(19) United States
(12) Patent Application Publication
(10) Pub. No.: US 2011/0141855 A1
(43) Pub. Date: Jun. 16, 2011

(54) SYSTEM AND METHOD FOR UPDATING INFORMATION IN ELECTRONIC CALENDARS

(75) Inventors: Thomas A. Gault, Troy, MI (US); Yaovi S. Bruce, Lake Orion, MI (US)

(73) Assignee: GENERAL MOTORS LLC, DETROIT, MI (US)

(21) Appl. No.: 12/636,553

(22) Filed: Dec. 11, 2009

(51) Int. Cl. G04B 19/24; G10L 15/26; G04B 47/00

(52) U.S. Cl. 368/10; 704/235; 704/E15.043; 368/28

(57) ABSTRACT

Systems and methods for updating information in an electronic calendar are disclosed. One example of the method includes recording a voice-tag memo via an in-vehicle telematics unit, the voice-tag memo containing information related to a calendar appointment, a calendar contact, or combinations thereof. The voice-tag memo is then converted into text via a speech-to-text unit in operative communication with the in-vehicle telematics unit. The method further includes determining, via a calendar comparator of an Internet-enabled program hosting the electronic calendar and in operative communication with the speech-to-text unit, which calendar appointment, calendar contact, or combinations thereof the voice-tag memo is associated with; and uploading the text to an appropriate cell of the calendar. The appropriate calendar cell is selected based upon which calendar appointment and/or calendar contact has the voice-tag memo associated therewith.

### TECHNICAL FIELD

The present disclosure relates generally to a system and method for updating information in electronic calendars.

### BACKGROUND

Business owners and their employees often use electronic calendars to keep track of appointments and maintain current contact information. Such calendars may be local on a particular electronic device (e.g., a personal computer, laptop notebook, netbooks, etc.), and may be synched with other mobile devices (e.g., mobile phones, personal digital assistants (PDAs), etc.). The calendar information may be particularly useful for keeping schedules and maintaining organization.

### SUMMARY

Systems and methods for updating information in an electronic calendar are disclosed. One example of the method includes recording a voice-tag memo via an in-vehicle telematics unit, the voice-tag memo containing information related to a calendar appointment, a calendar contact, or combinations thereof. The voice-tag memo is then converted into text via a speech-to-text unit in operative communication with the in-vehicle telematics unit. The method further includes determining which calendar appointment, calendar contact, or combinations thereof the voice-tag memo is associated with; and uploading the text to an appropriate cell of the calendar. The appropriate calendar cell is selected based upon which calendar appointment and/or calendar contact has the voice-tag memo associated therewith.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram of an example of the system for updating electronic calendar information;

FIG. 2 is a schematic diagram of one month of the electronic calendar;

FIG. 3 is a schematic diagram of one contact entry of the electronic calendar; and

FIG. 4 is a flow diagram of examples of the method for updating electronic calendar information.

### DETAILED DESCRIPTION

Examples of the method and system disclosed herein advantageously enable a user to manage client and personal information. The system includes an electronic Gregorian calendar including contact entries that is linked to one or more vehicles of the user. A user may input a voice-tag memo to the vehicle, and ultimately the information associated with the voice-tag memo is uploaded to the calendar.

It is to be understood that, as used herein, the term “user” includes vehicle owners, operators, and/or passengers. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in communication with the other component (notwithstanding the presence of one or more additional components therebetween). Additionally, two components may be permanently, semi-permanently, or releasably engaged with and/or connected to one another.

It is to be further understood that “communication” is to be construed to include all forms of communication, including direct and indirect communication. Indirect communication may include communication between two components with additional component(s) located therebetween.

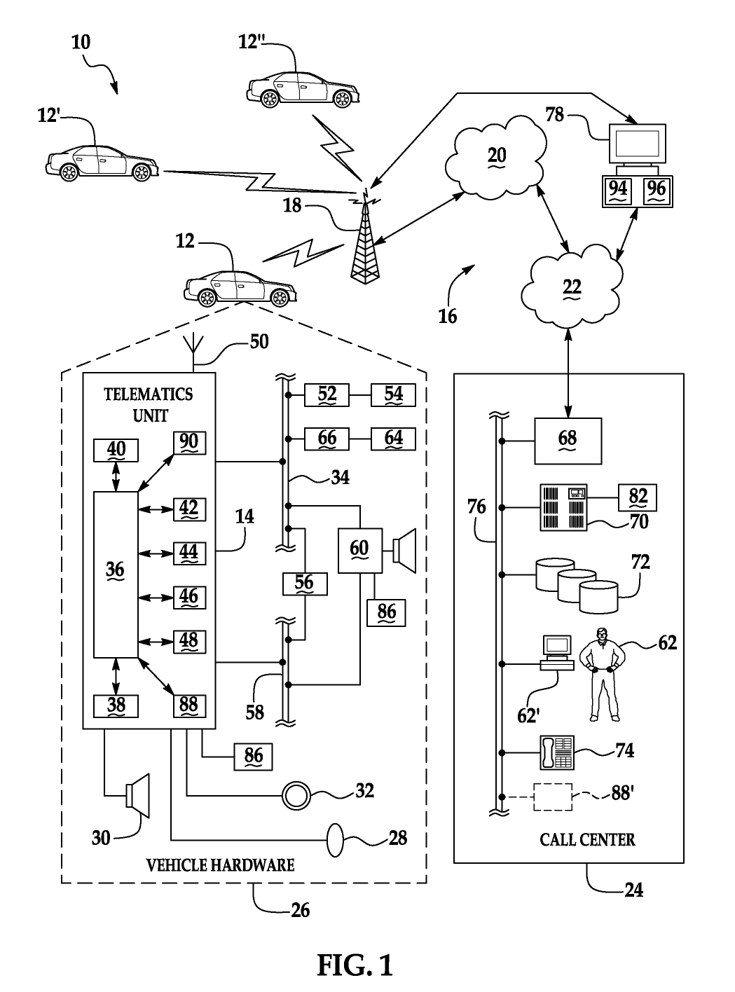

Referring now to FIG. 1, the system 10 includes one or more vehicles 12, 12′, 12″ (each of which includes a telematics unit 14), a wireless carrier/communication system 16 (including, but not limited to, one or more cell towers 18, one or more base stations and/or mobile switching centers (MSCs) 20, one or more land networks 22, one or more service providers (not shown)), one or more call centers 24, and an Internet-enabled program 78. In an example, the wireless carrier/communication system 16 is a two-way radio frequency communication system.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicles 12, 12′, 12″ are mobile vehicles, such as a motorcycle, car, truck, recreational vehicle (RV), boat, plane, etc., and are equipped with suitable hardware and software that enables them to communicate (e.g., transmit and/or receive voice and data communications) over the wireless carrier/communication system 16. It is to be understood that the vehicles 12, 12′, 12″ may also include additional components suitable for use in the telematics unit 14. The vehicles 12, 12′, 12″ may be individually owned, or may be owned by a business that uses a number of vehicles (i.e., a fleet) in operation in their ordinary course of business.

Some of the vehicle hardware 26 is shown generally in FIG. 1, including the telematics unit 14 and other components that are operatively connected to the telematics unit 14. While the vehicle hardware 26 is shown as being operatively disposed in vehicle 12, it is to be understood that each vehicle 12, 12′, 12″ has vehicle hardware 26 disposed therein as well. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), a dual antenna 50, a recorder 90, and, in some instances, a speech-to-text unit 88. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

In FIG. 1, the speech-to-text unit 88 is shown in the telematics unit 14. The speech-to-text unit 88 includes speech recognition software and is in operative communication with a recorder 90. In one example, when a user wishes to record a voice-tag memo in the vehicle 12, he/she presses an in-vehicle button to initiate the recorder 90. In response to an in-vehicle prompt that the recorder 90 is recording (e.g., an audible beep or a blinking light), the user speaks, and the recorder 90 records such utterance(s). The recorded utterance is then transmitted to the speech-to-text unit 88, and the speech recognition software of the unit 88 is configured to convert the recorded utterance(s) into corresponding text.

In another example, the recorder 90 is a component of the telematics unit, and the speech-to-text unit 88′ is located at the call center 24 (as shown in phantom in FIG. 1). In such instances, the user may activate the recorder 90 as previously described, and when recording is complete, the telematics unit may be configured to initiate communication with the call center 24 to transfer the recording to the off-board speech-to-text unit 88′. As described hereinbelow, a voice channel or packet data may be used to transmit the recorded data. Once the recording is transmitted to the speech-to-text unit 88′, the speech recognition software converts the recorded utterance(s) into corresponding text. The storage and/or use of the generated text is discussed further hereinbelow in reference to the other Figures.

The telematics unit 14 provides numerous services, some of which may not be listed herein. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications preferably use radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services. In still another example, one of the buttons 32 may be used to initiate the recorder 90.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58. The audio component 60 may also include software for receiving alerts from other vehicles 12 using the method(s) disclosed herein.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, and/or the like. Non-limiting example sensor interface modules 66 include powertrain control, climate control, body control, and/or the like.

In a non-limiting example, the vehicle hardware 26 includes a display 86, which may be operatively connected to the telematics unit 14 directly, or may be part of the audio component 60. Non-limiting examples of the display 86 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 16 may be a cellular telephone system or any other suitable wireless system that transmits signals between the vehicle hardware 26 and land network 22, and between the Internet-enabled program 78 and the land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 and Internet-enabled program 78 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions and, according to the example shown here, generally includes one or more switches 68, servers 70 and software 82 associated therewith, databases 72, live and/or automated advisors 62, 62′, as well as a variety of other telecommunication and computer equipment 74 that is known to those skilled in the art. These various call center components are coupled to one another via a network connection or bus 76, such as the one (vehicle bus 34) previously described in connection with the vehicle hardware 26.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or an automated response system 62′, and data transmissions are passed on to a modem (not shown) or other piece of equipment for demodulation and further signal processing. The modem preferably includes an encoder, as previously explained, and can be connected to various devices such as the server 70, database 72, and/or speech-to-text unit 88′. As shown, the server 70 may be associated with software 82, which supports the Internet-enabled program 78 that is accessible to subscribers via the Internet. The database 72 may be designed to store subscriber profile records, subscriber behavioral patterns, vehicle data, or any other pertinent subscriber information. As previously discussed, the off-board speech-to-text unit 88′ may be located at the call center 24 and used to generate text from incoming voice-tag memos.

It is to be appreciated that the call center 24 may be any central or remote facility, manned or unmanned, mobile or fixed, to or from which it is desirable to exchange voice and data communications.

Furthermore, although a service provider (not shown) may be located at the call center 24, the call center 24 is a separate and distinct entity from the service provider. In an example, the service provider is located remote from the call center 24. A service provider provides the user with telephone and/or Internet services. In an example, the service provider is a wireless carrier (such as, for example, Verizon Wireless®, AT&T®, Sprint®, etc.). It is to be understood that the service provider may interact with the call center 24 to provide service(s) to the user.

The system 10 also includes the Internet-enabled program 78, which is in selective communication with the server 70 (and associated software 82) of the call center 24 (e.g., via wireless carrier/communication system 16 or some other suitable communication system). The Internet-enabled program 78 is supported and hosted by one or more servers (not shown) that are capable of communicating with the call center 24. The Internet-enabled program 78 includes an electronic calendar 94 that enables a user to store information related to appointments (e.g., appointment dates, times, locations, etc.), contacts (e.g., contact name, phone numbers, address(es), business information, personal information, etc.), or the like.

A user (e.g., an individual vehicle owner, a fleet manager and/or owner, or the like) signs up to utilize the Internet-enabled program 78. Upon registering, the user is given an initial password and login ID, both of which may be customized by the user after the initial registration process is complete. An account is set up for the user, which may include a name and/or company name associated with the account, a fleet account number, an executive or other person associated with the account, contact information, billing information, etc. The subscriber can enroll via one of several methods. As one method, the subscriber can enroll through a website associated with the Internet-enabled program 78, which may or may not be part of a more comprehensive vehicle services website. A second method for enrolling includes placing a voice call to a call center live advisor 62. The live advisor 62 has computer access to the subscriber's account information for the purpose of carrying out the enrollment.

The website of the Internet-enabled program 78 may include a homepage (not shown) including enrollment boxes, and login and ID boxes that enable a user to access his/her account. The homepage may also include convenient drop-down options for the user, for easy access to a plurality of reports (examples of which are described hereinbelow). The Internet-enabled program 78 is available 24 hours per day and 7 seven days per week, thus allowing a user flexibility in managing his/her calendar 94.

When a fleet owner signs up, he/she registers the vehicles 12, 12′, 12″ in the fleet (including vehicle ID, make and model, region in which vehicle is used, etc.), any other user's authorized to access the account (including their name, user ID, etc.), and/or designates any desirable parameters for the calendar 94 as a whole and/or for any particular vehicle 12, 12′, 12″ in the fleet. For example, the fleet owner may assign each member of his/her team a login and password so that he/she can access his/her individual calendar 94 without accessing other's calendars or general account information. Each individual user may then access their calendar 94 from one or more electronic devices (not shown).

The call center 24 may also be given access to the calendar(s) 94 once the user (e.g., an individual or a fleet manager) has i) subscribed for services associated with the call center 24 and ii) has agreed that the call center 24 may have such access. As an example, when a fleet manager signs up a plurality of vehicles 12, 12′, 12″ for telematics related services through the call center 24, each vehicle user in his fleet will have access to his/her own calendar 94 on the Internet-enabled program 78, and will be able to utilize one or more call centers 24 associated with such telematics related services. Furthermore, in this example, once the fleet account is set up with the call center 24, the fleet manager can enable the call center(s) 24 to transmit data to each electronic calendar 94 that is registered with the fleet manager's particular account.

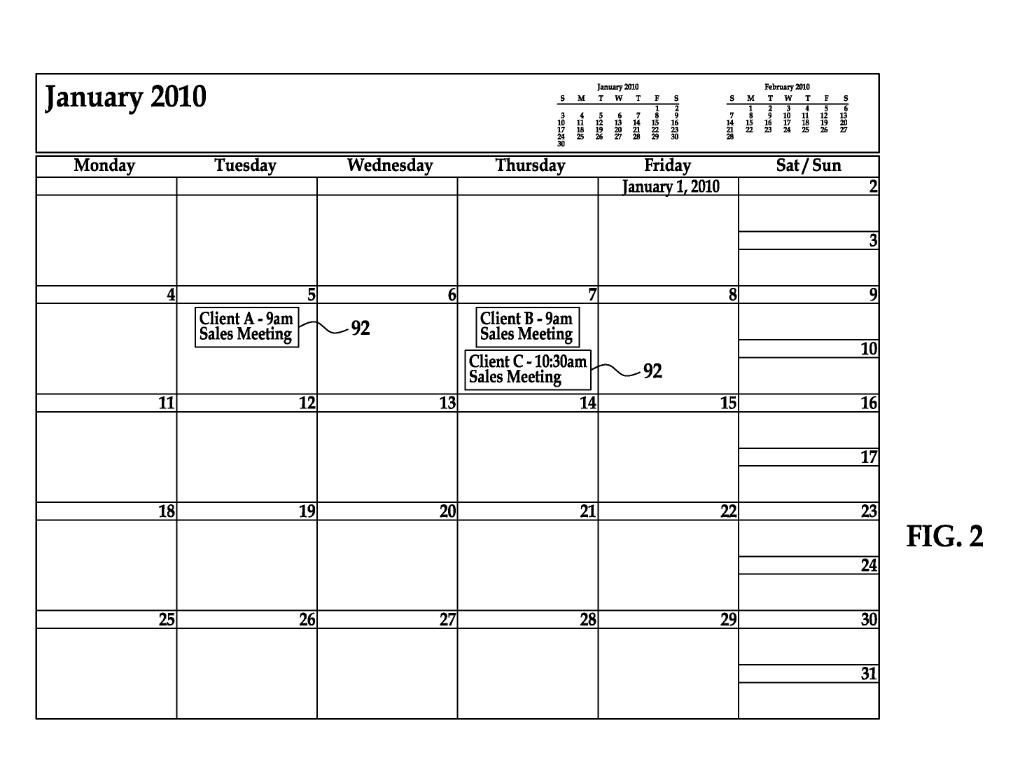

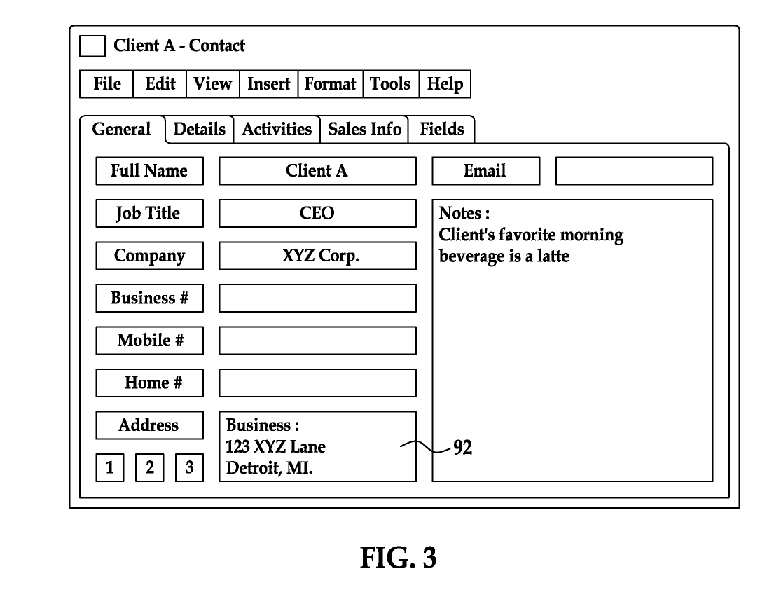

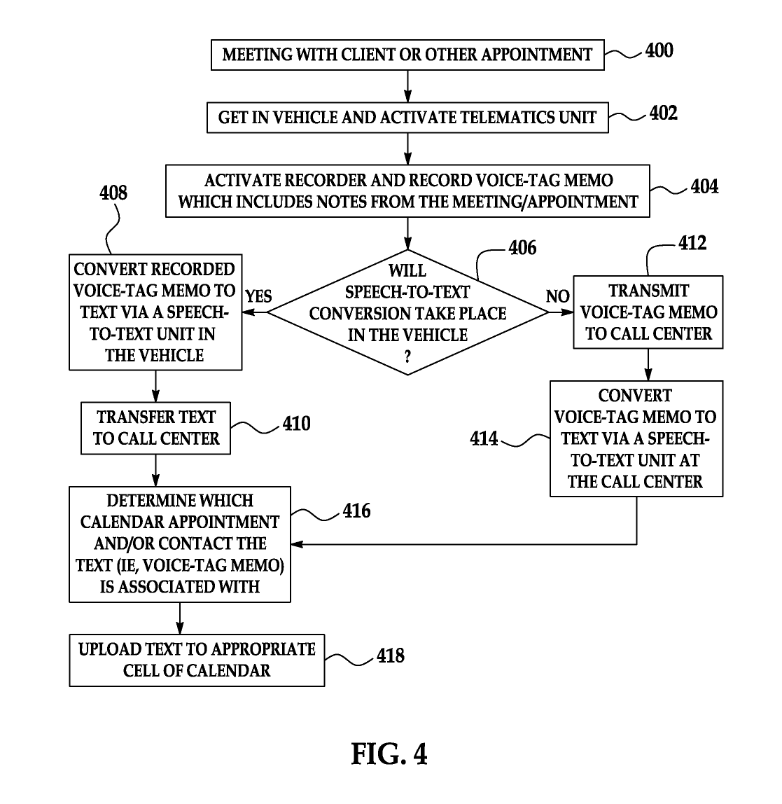

As mentioned, each individual who has subscribed to the Internet-enabled program 78 has access to his/her online calendar 94. The calendar 94 may be used to keep track of appointments (e.g., personal appointment, sales calls, client meetings, etc.), and to maintain up-to-date contact information (e.g., personal and/or business contacts). Examples of a calendar page and a client contact page that are viewable via the Internet-enabled program 78 are shown in FIGS. 2 and 3, respectively. In FIGS. 2 and 3, client/potential client appointments and contact information have been logged into appropriate cells 92 of the calendar 94 via any computer or electronic device capable of supporting and running the Internet-enabled program 78. As depicted in FIG. 2, the appointments may be shown on a monthly basis. However, it is to be understood that yearly, weekly, and daily calendar pages may also be accessed/viewed. As depicted in FIG. 3, various forms of contact information may be stored, including personal and business phone numbers, addresses, etc. Both of these aspects of the calendar 94 will be further discussed in reference to FIG. 4. The data entered into the calendar 94 is stored in the database 72, for example, and is linked to the user's profile.

Referring now to FIG. 4, examples of the method for updating information in the electronic calendar 94 of the Internet-enabled program 78 are depicted. The method begins (see reference numeral 400) when the user meets with a client or other person, and such meeting is stored in the user's calendar 94.

However, it is to be understood that the calendar 94 may be used prior to the meeting shown at reference numeral 400. In one example, the calendar 94 may be accessed in order to assist the user in getting to the meeting or preparing for the meeting. Since the calendar 94 is accessible via the call center 24 and the vehicle 12 is in operative communication with the call center 24, the user can request, from the vehicle 12, a number of items related to the calendar entries. As one example, the user may request that the appointment data logged in for that particular day be retrieved and delivered to an in-vehicle display 86. As another example, the user may request that the client address be retrieved and directions to such address be generated (via the call center 24 or an on-board navigation system) and delivered via the in-vehicle display 86 or audio system 60. As still another example, the user may request to review particular personal information that is stored (e.g., in a contact entry of the calendar 94) about the person with whom he/she is meeting. When the user makes such a request, the advisor 62 or 62′ is configured to retrieve the appropriate data from the database 72 and push such data to the vehicle 12.

Referring back to FIG. 4, as shown at reference numeral 402, once the meeting is finished and the user returns to the vehicle, he/she may begin an ignition ON cycle of the vehicle 12, or at least an ignition ON cycle of the telematics unit 14 (by activating the electronics, but not the engine). The user may wish to record a voice-tag memo about the meeting/appointment and/or about the person with whom he/she met. The information that the user may wish to record may include business details or notes, such as, e.g., sales information, products requested or of interest to the client, action items as a result of the meeting, or any other like information. The information may also include information about the person or people involved in the meeting, such as, e.g., new contact information (e.g., new phone number), personal information (e.g., spouses, kids or pets names; birthday; etc.), personal taste information (e.g., favorite coffee, favorite lunch place, dietary needs, etc.), or any other like information.

In order to record such a memo, the in-vehicle user activates the push button 32 that initiates the recorder 90. Once the recorder 90 is ready, the telematics unit 14 transmits a signal within the vehicle 12 that lets the user know to begin speaking. The user then iterates the utterances in the vehicle 12, which are amplified by the microphone 28 and recorded by the recorder 90.

When the recording is complete, the telematics unit 14 determines whether the recorded speech will be converted into text in the vehicle 12 or at the call center 24 (as shown at reference numeral 406). When the telematics unit 14 has the speech-to-text unit 88 therein (i.e., the unit 88 is on-board), the unit 14 is configured to automatically transmit the recording to the in-vehicle speech-to-text unit 88. The unit 88 then utilizes the speech recognition software to generate text that corresponds to the voice tag memo (as shown at reference numeral 408). In one example, the input speech is digitized and broken into phonemes, which are matched with representative phonemes in a dictionary or lexicon that correspond to one or more words. Any known speech-to-text technology may be utilized. In this system 10, utterances are received by the microphone 28 and recorded via recorder 90. The text-to-speech unit 88, 88′ digitizes the recorded utterances and contains or hardware (e.g., a microprocessor and memory) and software to perform the conversion. It is to be understood that in another example, the text-to-speech conversion is performed by the main processor in the telematics unit 14. Generally, the lexicon or dictionary is contained within the memory associated with the text-to-speech unit 88, 88′. The digitized utterances, typically parsed into representative phonemes, are compared with phonemes associated with words in the lexicon or dictionary. The phoneme or set of phonemes representing a word in the lexicon or dictionary that most closely matches the digitized phonemes representing the utterance is utilized. The word in the lexicon or dictionary is represented as text and is human understandable. Once generated, the text is then transferred to the call center 24, as shown at reference numeral 410.

However, when the speech-to-text unit 88′ is an off-board device (e.g., located at the call center 24), the telematics unit 14 transmits the recording to the call center 24 over a voice channel or as packet data, as shown at reference numeral 412. The uploading of the recording takes place during a vehicle data upload event. The vehicle data upload event takes place at some predetermined interval (e.g., all stored vehicle data is uploaded to the call center 24 every 20 minutes) or in response to some trigger (e.g., once the telematics unit 14 recognizes that the recording is complete). The telematics unit 14 may include a vehicle data upload (VDU) system (not shown), which is configured to receive raw vehicle data or recordings from the bus 34, packetize the data, and upload the packetized raw data to the call center 24 (or other external entity). The VDU is operatively connected to the processor 36 of the telematics unit 14, and thus is in communication with the call center 24 via the bus 34 and the wireless communication system 16. The VDU may be the telematics unit's central data system that can include a modem, a processor, and an on-board database. The database can be implemented using a separate network attached storage (NAS) device or be located elsewhere, such as in memory 38, as desired. The VDU system has an application program that handles all of the vehicle data upload processing, including communication with the call center 24 and the setting and processing of triggers.

The call center switch 68 is configured to recognize the data transmission and route the incoming text to the speech-to-text unit 88′. Similar to the on-board unit 88, the off-board unit 88′ utilizes internal speech recognition hardware and software to generate text that corresponds to the voice-tag memo (as shown at reference numeral 414).

Regardless of where the speech-to-text conversion takes place, after such conversion, a calendar comparator 96 of the Internet-enabled program 78 receives the text from the call center 24 and compares the information therein to information previously recorded in the electronic calendar 94 and stored in the database 72. The calendar comparator 96 is software of the Internet-enabled program 78 that is configured to identify which profile and calendar 94 to search by identifying the vehicle 12, 12′, 12″ which generated the voice-tag memo (and in some instances, which generated the corresponding text). When the transmission of the recording or text takes place, the vehicle 12, 12′, 12″ making such transmission is identified at the call center 24 via the mobile dialing number (MDN) associated with the vehicle 12, 12′, 12″. Any profile and calendar 94 associated with the calling vehicle 12, 12′, 12″ may be used for comparison purposes. In one example, the vehicle 12, 12′, 12″ will be associated with the user. In another example, such as a fleet situation, the calendar comparator 96 will cross-check the identified vehicle 12, 12′, 12″ with a then-current user (e.g., who is assigned to that vehicle 12, 12′, 12″ that particular day) because the day-to-day user may be different. Such cross-checking may be accomplished by checking an electronic list present on the Internet-enabled program 78 that has a log of which driver has which vehicle 12, 12′, 12″ at a particular time.

During the comparison, the calendar comparator 96 may compare a time and date stamp of the voice-tag memo with all appointments logged into the electronic calendar 94. For example, if a voice-memo and the corresponding text has a time and date stamp of 10:30 am, Jan. 5, 2010, the system may retrieve the appointment with Client A as a possible cell 92 for adding the text thereto (see, e.g., FIG. 2). In most instances, the calendar comparator 96 will also compare the content of the text with data pre-recorded in the calendar 94 to determine which appointment and/or contact entry the text is associated with. Using the previous example, if the text generated from the voice-tag memo also includes a person's name (e.g., Client A), the calendar comparator 96 may retrieve any appointments with Client A on or within a predetermined number of days of Jan. 5^{th}, and may also retrieve the contact entry for Client A (see FIG. 3).

Once calendar appointments and/or contact entries are identified as being associated with the text, the calendar comparator 96 determines which cells 92 or fields of the calendar 94 the text should be uploaded to. Each column and row in the calendar 94 has a date and time association, and such data may be used to identify the appropriate cells 92. A date and time stamp of the recording may be retrieved in a number of ways including, for example, the RTC 46 in the telematics unit 14 providing a time and date stamp that is accessed and provided to the converted speech file (i.e., the text), the GPS receiver 44 in the telematics unit 14 providing a time and date stamp that is accessed and provided to the converted speech file, or the cellular chip set 40 in the telematics unit 14 providing a time and date stamp that is accessed and provided to the converted speech file. In one example, the recording time and date is represented as text in a header portion of the converted speech file. The calendar comparator 96 extracts the time and date stamp of the recording and correlates it with a calendar row and column. Correlation is initially performed by matching times and dates. In some instances, correlation is also performed by matching other data (e.g., client name, sales information, updated contact info, spouse information, miscellaneous personal information, etc.) that may be extracted from the uploaded file. For example, if the user utters, “I just met with John Doe and XYZ corporation,” both “John Doe” and “XYZ corporation” may be extracted from the uploaded text file and correlated to text within the calendar 94. Generally, key words and phrase extraction, along with time and date stamps may be utilized to identify appropriate cells 92 for data upload. As another example, key phrases such as “change appointment” or “cancel appointment” may be indexed into software components of the calendar comparator 96 to subsequently perform these tasks when such phrases are identified in the analyzed text. The following are various examples of the uploading of the text data.

In one example, if the text states, “Jan. 5 appointment with Client A cancelled, rescheduled for Jan. 15, 2010, 10 am”, the calendar comparator 96 may utilize the dates and the client name to determine that the text is associated with the information in the cell 92 of the Jan. 5, 2010 calendar (shown in FIG. 2), and can upload the text to that appointment. In some instances, the calendar comparator 96 may be configured to input the cancellation notice in the cell 92 on Jan. 5, 2010, and incorporate the new appointment information in a cell 92 associated with Jan. 15, 2010.

In still another example, if the text states, “Client A prefers lattes and his new wife's name is Jane”, the system may utilize the client's name to query the electronic calendar 94 to determine which contact entry should be opened. Once Client A′s entry is identified, the system may determine which cells 92 should receive the information from the text. Which cells 92 are identified may depend on the format of the client entry. As shown in FIG. 3, the field of “notes” in the general tab of the client entry may be used to enter the information about Client A′s favorite morning beverage. Furthermore, the details tab of the client entry may include “family information” or “spouse's name” for entry of Client A's wifes's name.

If the system cannot determine an appropriate cell (e.g., there is no specific cell 92 for the client's favorite coffee), the system will simply upload the text to a notes or miscellaneous information cell (see FIG. 3), and the user can organize such information the next time he/she logs into his/her calendar 94.

Alternately, once the text is generated, the calendar comparator 96 may simply identify the calendar 94 with which the text is associated (by associating the vehicle 12 from which the voice-tag memo was generated with a profile at the call center 24 and calendar 94 of the Internet-enabled program 78), and just upload all of the text to the notes or miscellaneous information cell 92. This may be a setting that the user can select for his/her calendar 94, for example, if he/she wants the information to be available in the calendar 94 via the voice-tag memo method, but if he/she wants to be the one organizing such information into the more specific cells 92 of the calendar 94.

The user may also be provided with an update the next time he/she logs into his/her calendar 94, which informs the user where the text information has been added. This may be in the form of a list, or newly added text may appear in a pre-set or default color or font which distinguishes the newly added text from previously added and stored information. This feature allows the user to verify that his/her voice-tag memo has been added to the calendar 94 and that the information of the voice-tag memo has been entered into a desirable cell/field 92.

The updated calendar information may be retrieved at any desirable time by logging into the Internet-enabled program 78 or from within the vehicle 12, 12′, 12″ (e.g., when the user is on route to another appointment). In one example, the user may be on his/her way to a follow up appointment with Client A, may access Client A′s updated information from within the vehicle 12, 12′ 12″, and may stop to get Client A a latte after being reminded that this is Client A's favorite drink.

Since the information that is input is tailored to a specific contact and/or appointment, such information may be used to track, for example, sales information for a particular client, to follow up with the contact regarding a particular product or service discussed during a meeting, and/or to simply maintain a good relationship with a client (e.g., by purchasing his/her favorite beverage, remembering his/her birthday, etc.).

Furthermore, while the example discussed in reference to FIG. 4 involves a user who records a voice-tag memo after attending a meeting that was scheduled on his/her electronic calendar 94, it is to be understood that a voice-tag memo may be recorded at any time the user is in the vehicle 12, 12′, 12″. The process for generating corresponding text, analyzing the corresponding text, and associating such text with a calendar appointment and/or contact entry may be performed as described herein. For example, a user may run into a friend at a restaurant and be informed that the friend's address has changed. Upon entering his/her vehicle 12, 12′, 12″, the user may record a voice-tag memo identifying the friend and his/her new address. The voice-tag memo will be converted to text, and the method will be performed to add or update the friend's information in the user's electronic calendar 94. If an entry in the calendar is not found to be suitable for uploading the text, the Internet-enabled program 78 may store the information until the next user log-in period. At this log-in period, the user may be informed that the information has not been added to the calendar 94 and may be prompted to insert the information in an existing entry, create a new entry, and/or delete the information.

The methods disclosed herein enable on-the-spot recording of notes and other information from meetings, appointments, etc. from within the vehicle 12, 12′, 12″, and automatically filling of such information into the user's calendar. This system and method shorten the window for capturing such information, thereby reducing the possibility that such information is forgotten or lost.

While several examples have been described in detail, it will be apparent to those skilled in the art that the disclosed examples may be modified. Therefore, the foregoing description is to be considered exemplary rather than limiting.

1. A method for updating information in an electronic calendar, comprising:
recording a voice-tag memo via an in-vehicle telematics unit, the voice-tag memo containing information related to a calendar appointment, a calendar contact, or combinations thereof;
converting the voice-tag memo to text via a speech-to-text unit in operative communication with the in-vehicle telematics unit;
determining, via a calendar comparator of an Internet-enabled program hosting the electronic calendar and in operative communication with the speech-to-text unit, which calendar appointment, calendar contact, or combinations thereof the voice-tag memo is associated with; and
uploading, via the calendar comparator, the text to an appropriate cell of the calendar, the appropriate cell being selected based upon which calendar appointment, calendar contact, or combinations thereof has the voice-tag memo associated therewith.

2. The method as defined in claim 1 wherein the converting of the voice-tag memo to text is accomplished via the speech-to-text unit located in the vehicle, and wherein prior to the determining, the method further comprises transmitting the text to a call center in selective operative communication with the in-vehicle telematics unit, during a vehicle data upload event.

3. The method as defined in claim 1 wherein prior to the converting, the method further comprises transmitting the voice-tag memo from the in-vehicle telematics unit to the speech-to-text unit located at a call center in selective operative communication with the in-vehicle telematics unit.

4. The method as defined in claim 1 wherein the determining is accomplished by comparing content of the voice-tag memo with content logged into at least one of an appointment cell or a contact cell in the electronic calendar.

5. The method as defined in claim 4 wherein the comparing involves comparing at least one of a time or a date linked to the voice-tag memo with at least one of a time or a date time linked to the appointment cell in the electronic calendar.

6. The method as defined in claim 4 wherein the comparing involves comparing a name mentioned in the voice-tag memo with a name saved in a contact entry in the electronic calendar.

7. The method as defined in claim 1, further comprising retrieving the text uploaded to the calendar.

8. The method as defined in claim 7 wherein retrieving the text is accomplished via an electronic device in selective operative communication with the Internet-enabled program.

9. The method as defined in claim 1 wherein the information related to the calendar appointment, the calendar contact, or combinations thereof is selected from meeting information, sales information, product information, and personal information.

10. The method as defined in claim 1, further comprising storing the uploaded text in a database of a call center in operative communication with the Internet-enabled program.

11. A method for updating information in an electronic calendar, comprising:
recording a voice-tag memo via an in-vehicle telematics unit, the voice-tag memo containing information related to a client;
converting the voice-tag memo to text via a speech-to-text unit in operative communication with the in-vehicle telematics unit;
determining, via a calendar comparator of an Internet-enabled program hosting the electronic calendar and in operative communication with the speech-to-text unit, which client entry in the electronic calendar the voice-tag memo relates to by querying contact cells of the electronic calendar;
matching at least some content of the text to a contact entry of the electronic calendar; and
uploading the information to one or more appropriate cells of the contact entry.

12. The method as defined in claim 11 wherein the matching includes matching a name included in the text with a name associated with the contact entry of the electronic calendar.

13. A system for updating information in an electronic calendar, the system comprising:
an in-vehicle telematics unit including a recordation device configured to record a voice-tag memo containing information related to a calendar appointment, a calendar contact, or combinations thereof;
a speech-to-text unit in operative communication with the in-vehicle telematics unit and configured to convert the recorded voice-tag memo to text;
a calendar comparator of an Internet-enabled program that hosts the electronic calendar and is in operative communication with the speech-to-text unit, the calendar comparator configured to determine which calendar appointment, calendar contact, or combinations thereof the voice-tag memo is associated with; and
the electronic calendar configured to receive the text in an appropriate cell, the appropriate cell being selected based upon which calendar appointment, calendar contact, or combinations thereof has the voice-tag memo associated therewith.

14. The system as defined in claim 13 wherein the speech-to-text unit is located in the vehicle, and wherein the system further comprises a call center in selective operative communication with the in-vehicle telematics unit, the call center configured to receive the text during a vehicle data upload event.

15. The system as defined in claim 13 wherein the speech-to-text unit is located at a call center in selective operative communication with the in-vehicle telematics unit.

16. The system as defined in claim 13 wherein the information related to the calendar appointment, the calendar contact, or combinations thereof is selected from meeting information, sales information, product information, and personal information.
